(19) United States
(12) Patent Application Publication
(10) Pub. No.: US 2022/0281210 A1
(43) Pub. Date: Sep. 8, 2022

(54) FLOOR AND WALL MAT AND METHOD OF MAKING THE SAME

(71) Applicant: D.C. Humphrys Co. Inc., Philadelphia, PA (US)

(72) Inventors: Ronald B. NISSENBAUM, Haverford, PA (US); Steven Michael POWELL, Media, PA (US)

(21) Appl. No.: 17/191,146

(22) Filed: Mar. 3, 2021

(51) Int. Cl. B32B 27/06; B32B 7/08; B32B 27/36; B32B 5/18; B32B 27/30; B32B 3/10

(52) U.S. Cl. CPC B32B 27/065; B32B 7/08; B32B 27/36; B32B 5/18; B32B 27/30; B32B 3/10; B32B 2607/02; B32B 2471/04

(57) ABSTRACT

A method of manufacturing a mat is provided. The method involves securing a first layer formed of a polymer within a base die, positioning an intermediate cushion layer on top of the first layer, securing a second layer formed of the polymer to the base die, and securing a perimeter of the first layer to a perimeter of the second layer by radio-frequency welding, so as to envelop the intermediate cushion layer within the first and second layers and thereby form the mat. The first layer has a first surface and an opposing second surface in contact with the base die. The intermediate cushion layer has a first surface and an opposing second surface in contact with the first surface of the first layer. The second layer has a first surface and an opposing second surface in contact with the first surface of the intermediate cushion layer.

### BACKGROUND OF THE INVENTION

The present invention relates to a resilient mat, such as a floor mat or a wall mat, and a method of making such a resilient mat. More specifically, the present invention is directed to a method of making resilient floor and wall mats which can be used in playroom environments, athletic environments such as for gymnastics or other types of exercise, and any environment where cushioning of a hard surface is desired.

Conventional floor and wall mats are typically constructed by stitching together two vinyl sheets of materials with a polyurethane foam layer sandwiched therebetween. More particularly, first the two vinyl sheets are stitched together along three matched edges to form a pocket. Next, the foam layer is inserted in the pocket, and finally the last edges of the vinyl sheets are stitched together. Constructing mats in this manner is a time consuming and labor-intensive process, and therefore is a costly process. The time, labor and cost inefficiencies are amplified when making a folding mat, as individual mats must be made by the above-described process and then a further step is required to stitch the mats together, and this process is repeated until a foldable mat of the desired dimensions and number of folds is obtained.

Therefore, it is desirable to provide an efficient method of making resilient floor and wall mats which does not require any sewing or stitching, but which ensures that the edges of the mat are securely fixed together so as to envelop the cushion material situated therein.

### BRIEF SUMMARY OF THE INVENTION

Briefly stated, an embodiment of the present invention is directed a method of manufacturing a floor mat or wall mat. The method involves securing a first layer formed of a polymer within a base die, the first layer having a first surface and an opposing second surface in contact with the base die; positioning an intermediate cushion layer on top of the first layer, the intermediate cushion layer having a first surface and an opposing second surface in contact with the first surface of the first layer; securing a second layer formed of the polymer to the base die, the second layer having a first surface and an opposing second surface in contact with the first surface of the intermediate cushion layer; securing a perimeter of the first layer to a perimeter of the second layer by radio-frequency (RF) welding, so as to envelop the intermediate cushion layer within the first and second layers and thereby form the floor mat or wall mat.

### BRIEF DESCRIPTION OF THE DRAWINGS

The following detailed description of the invention will be better understood when read in conjunction with the appended drawings. For the purpose of illustrating the invention, there is shown in the drawings an embodiment which is presently preferred. It should be understood, however, that the invention is not limited to the precise arrangements and instrumentalities shown.

In the Drawings:

FIG. 1 is a top perspective view of a first layer secured within a first die according to a preferred embodiment of a step of a method of manufacturing a mat according to the present invention;

FIG. 2 is an enlarged and partial view of a corner of the first layer shown in FIG. 1;

FIG. 3 is a top perspective view of an intermediate layer positioned atop the first layer in the first die according to a preferred embodiment of a step of a method of manufacturing a mat according to the present invention;

FIG. 4 schematically depicts a second die positioned above first die according to a preferred embodiment of a step of a method of manufacturing a mat according to the present invention;

FIG. 5 is a front and top perspective view of a finished mat according to an embodiment of the present invention;

FIG. 5A is an enlarged view of a corner of the mat shown in FIG. 5; and

FIG. 6 is a side view of a foldable mat according to an embodiment of the present invention.

### DETAILED DESCRIPTION OF THE INVENTION

Certain terminology is used in the following description for convenience only and is not limiting. The words “right”, “left”, “lower” and “upper” designate directions in the drawings to which reference is made. The words “inwardly” and “outwardly” refer to directions toward and away from, respectively, the geometric center of the device, product or component thereof and designated parts thereof. Unless specifically set forth herein, the terms “a”, “an” and “the” are not limited to one element but instead should be read as meaning “at least one”. The terminology includes the words noted above, derivatives thereof and words of similar import.

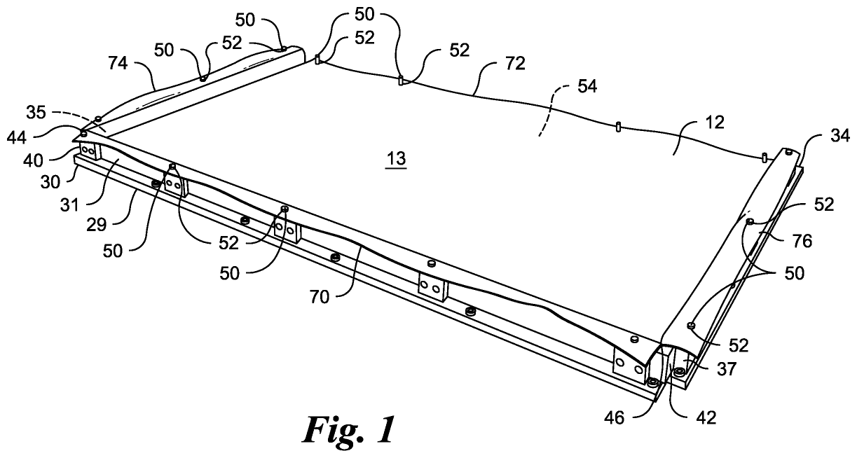

Referring to the drawings in detail, wherein like numerals and characters indicate like elements throughout, there are shown in FIGS. 1-5A a presently preferred embodiment of a floor or wall mat 10 and a method of manufacturing the floor or wall mat 10, in accordance with embodiments of the present invention. The mat 10 is formed of a first layer 12, a second layer 14 and an intermediate cushion layer 28 situated between the bottom layer 12 and the top layer 14.

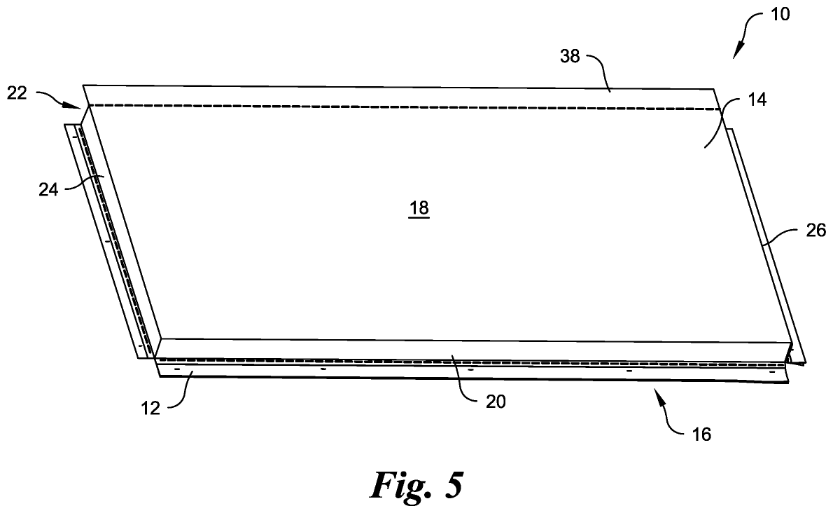

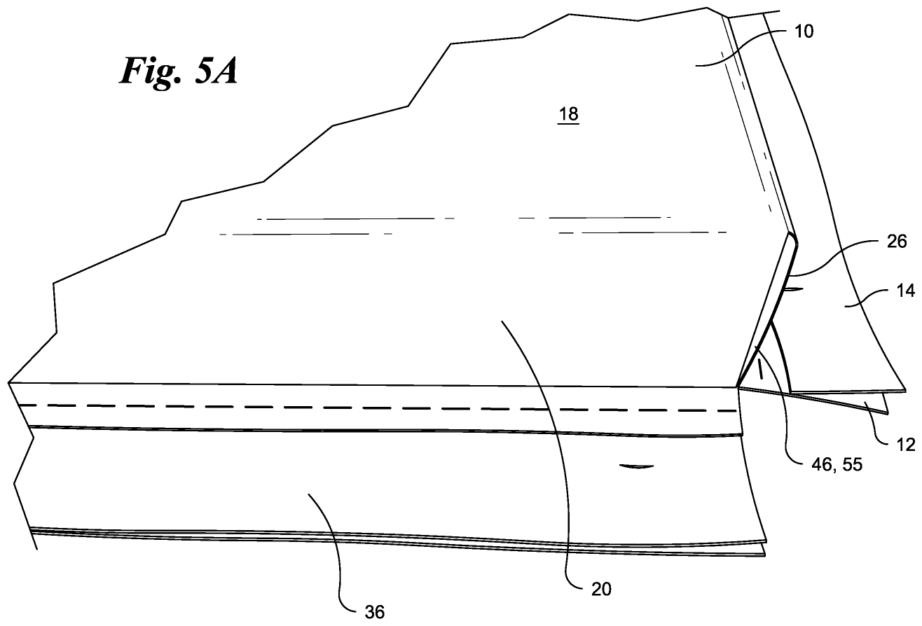

Referring to FIG. 5, the mat 10 has a planar body including a first main surface 16 and an opposing second main surface 18 which extends parallel to the first main surface 16. A periphery of the mat is formed by a first pair of side surfaces 20, 22 and a second pair of side surfaces 24, 26. The side surfaces 20, 22 of the first pair extend parallel to each other, and the side surfaces 24, 26 of the second pair extend parallel to each other and perpendicular to the first pair of side surfaces 20, 22.

When the mat 10 has a rectangular shape, as shown in FIG. 5, the first pair of side surfaces 20, 22 are long sides of the mat 10, while the second pair of side surfaces 24, 26 are short sides of the mat 10.

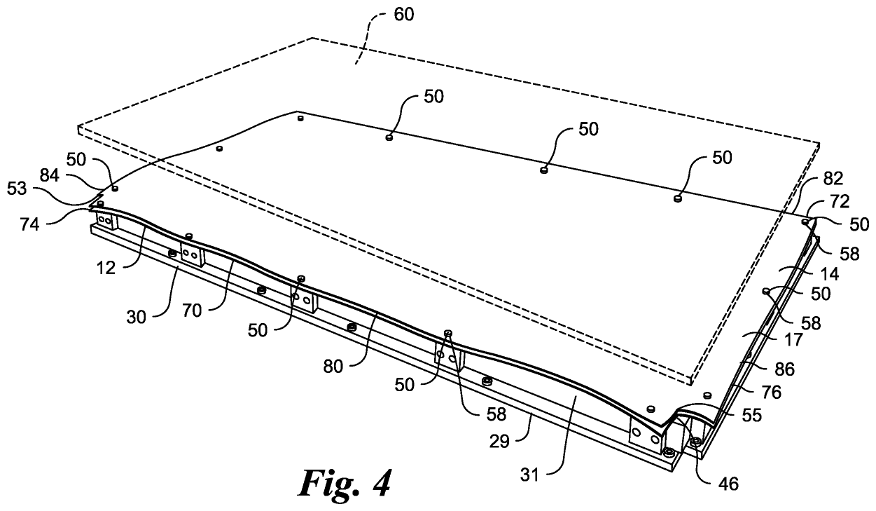

The first layer 12 forms the first main surface 16 of the mat 10 and the second layer 14 forms the second main surface 18 of the mat 10. Referring to FIG. 1, the first layer 12 has a first surface 13 and an opposing second surface 15, as well as a first pair of edges 70, 72 which extend parallel to each other, and a second pair of edges 74, 76 which extend parallel to each other and perpendicular to the first pair of edges 70, 72. Referring to FIG. 4, the second layer 14 similarly has a first surface 17 and an opposing second surface (not visible in FIG. 4), as well as a first pair of edges 80, 82 which extend parallel to each other, and a second pair of edges 84, 86 which extend parallel to each other and perpendicular to the first pair of edges 80, 82.

The first layer 12 and the second layer 14 may be made of the same material or a different material. Preferably, however, the first layer 12 and the second layer 14 are made of the same material. Each of the first layer 12 and the second layer 14 may be made from any suitable material, such as, but not limited to, a polymer, and more particularly plastic, material. More specifically, each of the first layer 12 and the second layer 14 may be made of a vinyl polymer (e.g., polyvinyl chloride), polyethylene, thermoset elastomer, thermoplastic elastomer, rubber, rubber-like material, ethylene vinyl acetate, nylon, polyester and the like. It will be understood by those skilled in the art that the first layer 12 and/or the second layer 14 may be made of any material which is water resistant and wear resistant and suitable for repetitive use. Preferably, each of the first layer 12 and the second layer 14 is made of a vinyl material, and more preferably a coated or extruded vinyl fabric. Each of the first layer 12 and the second layer 14 preferably has a thickness ranging from approximately 0.001 to approximately 0.05 inches, and more preferably approximately 0.01 inches.

In a preferred embodiment, the material of each of the first and second layers 12, 14, or at least the exposed surface of each layer 12, 14, is or has been treated to be one or more of antibacterial, antimicrobial, water resistant, wear resistant, slip resistant, toxin-free, mold resistant, mildew resistant, hypoallergenic, fire retardant and the like.

The intermediate cushion layer 28, which is positioned between the first and second layers 12, 14 in the finished mat 10, is preferably made of polyester foam, open-cell foam (e.g., polyurethane foam), polyethylene foam, polymer fibers (e.g., polyester fibers), open-cell rubber. In a preferred embodiment, the intermediate layer 28 is formed of a polyester-based material manufactured and sold by Indratech®, which is constructed of randomly oriented, non-woven polyester fibers interlinked to one another by a binder so as to exhibit cushioning properties similar to polyester foam.

Referring to FIG. 1, to manufacture the mat 10, the first layer 12 is placed in a first die or base die 30. The first die 30 is preferably sized and shaped to conform to the desired dimensions of the mat 10. Referring to FIG. 1, in one embodiment, the first die 30 has a base plate 29, a first sidewall 31 extending in a first direction, a second sidewall 35 extending in a second direction that is perpendicular to the first direction, and a third sidewall 37 extending in the second direction. As such, the first die 30 has three raised edges defined by the first, second and third sidewalls 31, 35, 37, respectively, and one flat edge 34. A cavity 54 is formed and bounded by the base plate 29 and first, second and third sidewalls 31, 35, 37. The second surface 15 of the first layer 12 is in contact with the first die 30, and more particularly with the base plate 29 and the first, second and third sidewalls 31, 35, 37.

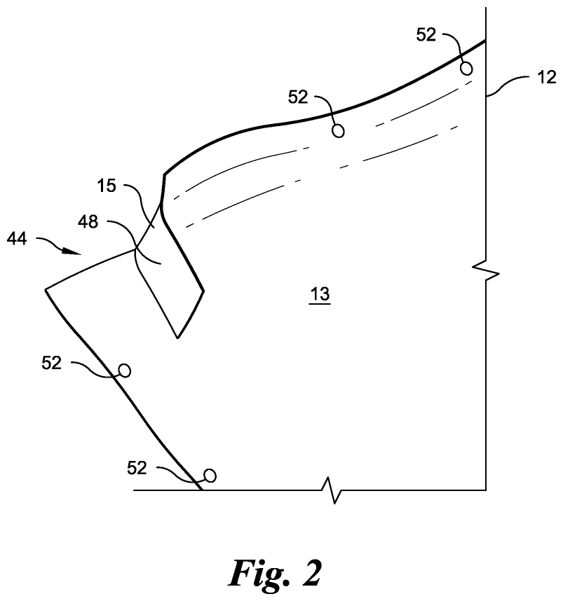

The first die 30 has a first corner 40 formed by the intersecting sidewalls 31, 35 and a second corner 42 formed by the intersecting sidewalls 31, 37. Referring to FIGS. 1-2, first and second corners 44, 46 of the first layer 12, which are configured to be situated in the first and second corners 40, 42 of the first die 30, are cut so as to form a free flap 48. When the first layer 12 is positioned in the first die 30, the flap 48 at each corner 44, 46, is folded and tucked in, in the manner shown in FIG. 2, such that the first layer 12 lays flat in the cavity 54 of the first die 30 and its peripheral edges 70, 72, 74, 76 overlay the corresponding edges of the first die 30 without any bunching of the material.

Along at least one edge of the first die 30, and more preferably along each edge of the first die 30, a plurality of pegs 50 are provided at spaced-apart intervals. The plurality of pegs 50 protrude upwardly away from the base plate 29 of the first die 30. Along at least one edge 70, 72, 74 or 76 of the first layer 12, and more preferably along each edge 70, 72, 74, 76 of the first layer 12, a plurality of holes 52 are formed at spaced-apart intervals and extend through the body of the first layer 12 from the first surface 13 to the second surface 15. The positions of the plurality of holes 52 correspond to the positions of the plurality of pegs 50. As such, as the first layer 12 is positioned in the first die 30, each upwardly projecting peg 50 of the first die 30 is received within and through a corresponding hole 52 of the first layer 12. The first layer 12 is therefore securely retained within the first die 30.

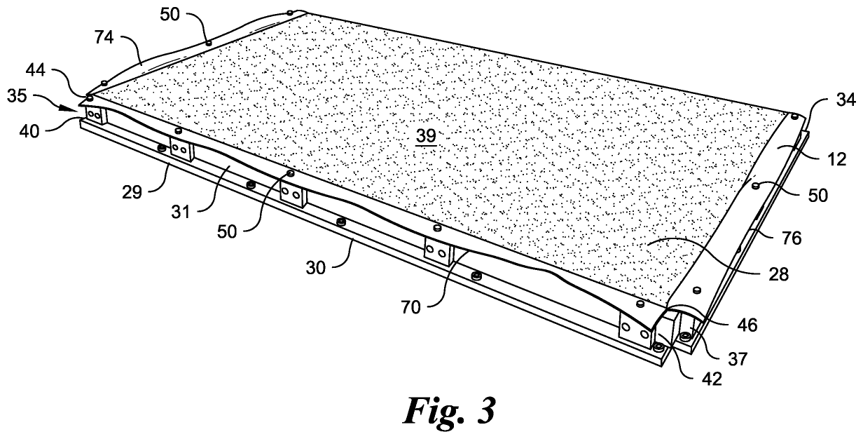

As shown in FIG. 3, after the first layer 12 is secured within the first die 30, the intermediate layer 28 is positioned in the cavity 54 on top of the first layer 12. More particularly, the intermediate layer 28 has a first surface 39 and an opposing second surface (not visible) in contact with the first surface 13 of the first layer 12. The intermediate layer 28 is dimensioned and shaped so as to fit securely in the cavity 54 in a tight fit.

Next, as shown in FIG. 4, the second layer 14 is positioned atop the intermediate layer 28, such that the first pair of edges 80, 82 and second pair of edges 84, 86 of the second layer 14 are respectively aligned with the first pair of edges 70, 72 and second pair of edges 74, 76 of the first layer 12, and such that the second surface of the second layer 14 is in contact with the first surface 39 of the intermediate layer 28. First and second corners 53, 55 of the second layer 14 are each provided with a cutout to match the shape and dimensions of the corresponding corners 44, 46 of the first layer 12. Along at least one edge 80, 82, 84 or 86 of the second layer 14, and more preferably along each edge 80, 82, 84, 86 of the second layer 14, a plurality of holes 58 are formed at spaced-apart intervals and extend through the body of the second layer 14 from the first surface 17 to the second surface. The positions of the plurality of holes 58 of the second layer 14 correspond to the positions of the plurality of pegs 50 and the plurality of holes 52 of the first layer 12. As such, as the second layer 14 is positioned on the first die 30, each upwardly projecting peg 50 of the first die 30 is received within and through a corresponding hole 58 of the second layer 14, as well as a corresponding hole 52 of the first layer 12. The second layer 14 is therefore securely retained to the first die 30.

Finally, the first layer 12, intermediate layer 28 and second layer 14, as assembled within the first die 30, are subjected to heat welding or heat sealing, and more particularly radio frequency heat welding or radio frequency (RF) heat sealing. The terms RF heat welding and RF heat sealing are utilized synonymously herein to describe a heating process that utilizes RF waves to generate the energy to heat the polymer material of the first and second layers 12, 14, and create a weld or seal by molecular action.

To create the RF seals, the first die 30 with the assembled layers 12, 28, 14 is conveyed to a RF sealer device. In the RF sealer device, a perimeter of the first layer 12 is secured to a perimeter of the second layer 14 by RF welding, such that the intermediate layer 28 is enveloped with the joined first and second layers 12, 14.

More particularly, in the RF sealer device, a second die press 60 is positioned above the first die 30 and assembled layers 12, 28, 14. Upon actuation of the RF sealer device, the second die 60 is brought down on top of the assembled layers 12, 28, 14, so as to contact the first surface 17 of the second layer 14. In doing so, pressure and RF waves are applied to the material of the first and second layers 12, 14 along each of the peripheral edges 70, 72, 74, 76 and 80, 82, 84, 86 of each layer 12, 14. Pressure and RF waves are applied for a predetermined time period sufficient to create RF welds along each of the peripheral edges 70, 72, 74, 76 and 80, 82, 84, 86 to thereby join together the first and second layers 12, 14 and envelop the intermediate layer 28 therein. Each RF weld may be formed simultaneously or in a multi-step process (i.e., pressure and RF waves are first applied along joined edges 70 and 80 to create a RF weld, next pressure and RF waves are applied along joined edges 72 and 82 to create another RF weld, and so forth). More particularly, upon the application of pressure and exposure to an RF field, the first and second polymer layers 12, 14 are brought to a liquid or near-liquid state and subsequently blended into a single layer by the RF weld.

The first die 30 and the second die 60 are preferably components of a RF sealer. The RF sealer preferably has a 15 KW output. Preferably, the RF sealer is a 15 KW sealer manufactured and sold by Kabar®. The seal time for sealing together the first and second layers 12, 14 preferably ranges from approximately 2 seconds to approximately 12 seconds, more preferably approximately 3 seconds to approximately 8 seconds, and most preferably approximately 3 seconds to approximately 4 seconds.

The first die 30 and the second die 60 are preferably made of aluminum. The first die 30 and the second die 60 preferably each has a thickness of one-half inches.

It will be understood that all of the above parameters for the RF sealing process and for the RF sealer may vary depending upon the material used and the thickness of the first layer 12 and/or second layer 14.

In one embodiment, a predetermined duration elapses after the second die press 60 closes on the first die 30 and before the RF heating cycle begins. During this predetermination duration, the second die press 60 applies pressure to the assembled layers to stabilize them and ensure firm contact of the layers 12, 14. This so-called “pre-seal” time is preferably only a matter of seconds, more preferably approximately 1 to 5 seconds, preferably approximately 2 seconds.

In one embodiment, a predetermined duration elapses after the RF heating cycle is completed and before the second die press 60 is lifted off of the assembled layers 12, 14. During this predetermination duration, the second die press 60 applies pressure to the assembled layers. This so-called “post-seal” time is preferably only a matter of seconds, more preferably approximately 1 to 5 seconds, preferably approximately 2 seconds.

It will be understood by those skilled in the art that the pre-seal, seal and post-seal times may vary based on the material used and the thickness of the first layer 12 and/or second layer 14.

Optionally, if there is excess material between the RF weld and the respective peripheral edge 70, 72, 74, 76, 80, 82, 84, 86, the excess material may be cut away or otherwise removed from the finished mat 10.

In one embodiment, as shown in FIGS. 5-5A, when the second die 60 applies pressure to the areas along the joined peripheral edges 70, 72, 74, 76 and 80, 82, 84, 86, an imprint mimicking stitching is also imparted along each RF weld. As such, the RF welded mat 10 has the appearance of a conventional stitched mat.

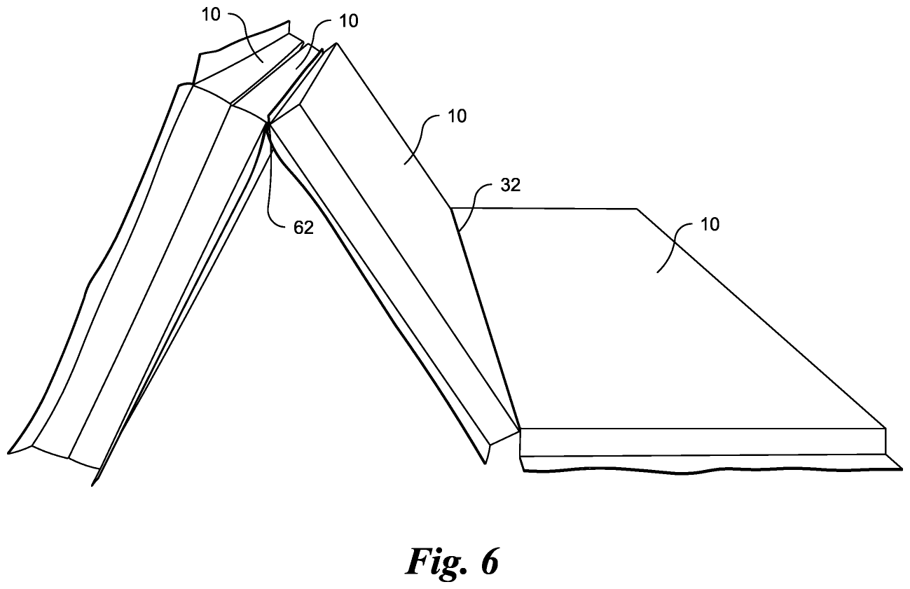

Referring to FIGS. 5-5A, because the edge 34 of the first die 30 is a flat edge, after the RF welding process, a free flap or tail 38 of material comprising the first layer 12 and/or second layer 14 is formed along the side surface 22 of the mat 10. The tail 38 lies in the same plane as the second surface 18 of the mat 10. The tail 38 enables the mat 10 to be secured to another mat 10, so as to form a foldable mat. More particularly, the tail 38 of a first mat 10 is aligned with the tail 38 of a second mat 10, and the aligned tails 38 are then subjected to RF welding under the same conditions as discussed above, in order to join together the first and second mats 10. The RF weld between the first and second mats 10 defines a first fold line 32. Similarly, the excess material formed along the side surface 20 of the mat 10 is a second tail 36 which lies in the same plane as the first surface 16 and which need not be cut off as described above. Instead, the second tail 36 of a first mat 10 may be RF welded to the second tail 36 of another mat 10, so as to join together the mats 10, along a second fold line 62. As such, the present invention provides a method for manufacturing a foldable floor or wall mat 10, as shown in FIG. 6.

It will be understood that where a foldable mat 10 is not desired, and rather a stand-along single mat 10 is desired, the edge 34 of the first die 30 need not be flat, but instead may include a sidewall such that the first die 30 would include a fourth raised edge. In such a configuration of the first die 30, the tail 38 would not be formed.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method of manufacturing a floor mat or wall mat, the method comprising:
securing a first layer formed of a polymer within a base die, the first layer having a first surface and an opposing second surface in contact with the base die;
positioning an intermediate cushion layer on top of the first layer, the intermediate cushion layer having a first surface and an opposing second surface in contact with the first surface of the first layer;
securing a second layer formed of the polymer to the base die, the second layer having a first surface and an opposing second surface in contact with the first surface of the intermediate cushion layer;
securing a perimeter of the first layer to a perimeter of the second layer by radio-frequency (RF) welding, so as to envelop the intermediate cushion layer within the first and second layers and thereby form the floor mat or wall mat.

2. The method according to claim 1, wherein the polymer of the first layer and second layer is selected from the group consisting of a vinyl polymer, polyethylene, thermoset elastomer, thermoplastic elastomer, rubber, rubber-like material, ethylene vinyl acetate, nylon, and polyester.

3. The method according to claim 2, wherein the polymer is vinyl.

4. The method according to claim 1, wherein the intermediate cushion layer is formed of a material selected from the group consisting of polyester foam, open-cell foam, polyethylene foam, polymer fibers and open-cell rubber.

5. The method according to claim 4, wherein the intermediate cushion layer is formed of randomly oriented, non-woven polyester fibers interlinked to one another by a binder.

6. The method according to claim 1, wherein the radio-frequency welding is performed by a RF sealer having a 15 KW output.

7. The method according to claim 1, wherein the base die includes a plurality of spaced-apart pegs, and wherein at least one edge of each of the first layer and at least one edge of the second layer includes a plurality of spaced-apart holes, each peg of the base die being received within a corresponding hole of the first layer and second layer.

8. The method according to claim 1, comprising:
performing the method of claim 1 to manufacture a first mat,
repeating the method of claim 1 to manufacture a second mat, and
joining an edge of the first mat to an edge of the second mat by radio-frequency welding to form a fold line between the joined first and second mats.
